(19) United States
(12) Patent Application Publication
(10) Pub. No.: US 2012/0035983 A1
(43) Pub. Date: Feb. 9, 2012

(54) Method and system to compare business metrics

(75) Inventors: Woodrow Brian Taylor, Minneapolis, MN (US); Dena Glutz, Beaverton, OR (US)

(73) Assignee: Ceridian Corporation, Minneapolis, MN (US)

(21) Appl. No.: 12/806,266

(22) Filed: Aug. 9, 2010

(51) Int. Cl. G06Q 10/00

(52) U.S. Cl. 705/7.33

(57) ABSTRACT

A method and system provide information by which an audience made of one or more prospects or customers of payroll and benefits processing may compare its human capital metrics with human capital metrics of other customers. A customer database is maintained for each customer that includes demographic data, employee data and financial data for that customer. Each customer database is updated based on periodically processing payroll and benefits transactions for that customer. A benchmark database is created by aggregating selected fields of data from databases of customers of interest so that the benchmark database represents a sample of customers of interest. An audience database is created for the one or more prospects or customers forming the audience by retrieving the selected fields of data from the customer databases for the one or more customers forming the audience. The audience database is compared to the benchmark database, and results of the comparison are reported to the audience.

### BACKGROUND

Businesses often rely on the tracking of data to determine how well the business is doing. This data, which will be referred to as human capital metrics (“HCM”), can relate to various things, such as sales, orders, inventories, and costs (including the individual employees, salaries, benefits and demographics of the business). By collecting this data over time, a business can get an accurate snapshot of the overall health of the business.

One measure which can help to determine how a business is doing is comparing data of the business to data of similarly situated or competing businesses. This can help a business assess, for example, whether it compensates similarly to its peer businesses, whether the benefits are similar, whether it structures its management in the same way, and many other aspects of HCM.

A traditional method of collecting peer data is to survey a number of businesses, and aggregate the data from the surveys returned. This method relies on the receiving a statistically significant response to the survey as well as receiving accurate and truthful responses. This method also creates a lag time in the data, sometimes taking several months to a year to collect data and making it available for comparisons. It also introduces a bias in the interpretation of the requested data.

### SUMMARY

A method of providing information by which an audience of one or more prospects or customers of payroll and benefits processing may compare its human capital metrics (“HCM”) with HCM of other customers. This includes maintaining a database for each customer that contains demographic data, employee data and financial data for that customer; and updating each database based on periodically processing payroll and benefits transactions. It further includes creating a benchmark database by aggregating selected fields of data from databases of customers of interest so that the benchmark database represents a sample of customers of interest; creating an audience database for the one or more prospects or customers forming the audience by retrieving the selected fields of data from the customer databases for the one or more customers which make up the audience; comparing the audience database to the benchmark database; and reporting results of the comparison to the audience.

A system for providing information by which an audience of one or more prospects or customers of payroll and benefits processing may compare its HCM with HCM of other customers includes a processing system, a benchmarking system, and a reporting system. The processing system processes payroll and benefits transactions and updates a plurality of customer databases based on the processing, each database including demographic data, employee data and financial data for one customer. The benchmarking system includes a benchmarking processor which creates a benchmark database by aggregating selected fields of data from databases of customers of interest, creates an audience database by retrieving the selected fields of data from customer databases of the one or more prospects or customers making up the audience, and compares the audience database with the benchmarking database. The reporting system reports results of the comparison to the audience.

### BRIEF DESCRIPTION OF THE DRAWINGS

FIG. 1 is a block diagram illustrating a system for providing information by which an audience made of one or more prospects or customers of payroll and benefits processing may compare its human capital metrics with human capital metrics of other customers.

FIG. 2 is a block diagram illustrating a method of providing information by which an audience formed of one or more prospects or customers of payroll and benefits processing may compare its human capital metrics with human capital metrics of other customers.

FIG. 3 is a report comparing the human capital metrics of an audience database to the human capital metrics of a benchmark database according to an embodiment of the current invention.

FIG. 4 is a report comparing the human capital metrics of an audience database to the human capital metrics of a benchmark database, and plotting the metrics over time.

FIG. 5 is a block diagram illustrating a method of providing information by which an audience made of one or more prospects or customers of payroll and benefits processing may compare its human capital metrics with human capital metrics of other customers according to another embodiment.

### DETAILED DESCRIPTION

Businesses with employees have specific duties related to payroll which go far beyond issuing a check to every employee. There are many rules and laws which must be complied with, such as withholding to cover tax, social security, and Medicare; paying overtime; and withholding properly under the law for health and retirement benefits. The penalties for not complying with all laws for reporting and processing payroll can be severe. Due to the complications and possible penalties, many businesses hire an outside business that specializes in payroll and benefits processing to process these transactions.

A payroll and benefits processing company typically provides payroll services to a plurality of customers. In order to process the payroll transactions and issue a paycheck, the payroll processing company must collect a large amount of data, referred to as human capital metrics (“HCM”) or human capital metrics data (“HCM data”), related to the demographics, the individual employees and the specific payroll transactions. This data can specifically include employee and employer demographic data, employee compensation data, employee and employer taxation data, employee benefits data (medical, dental, vision, etc.), employer benefits data including both employer guidelines (401K match) and the relationship with vendors (e.g., dental vendor processing the offset of a co-pay), and ancillary services (e.g., employee relocation assistance programs). This data is stored in a customer database. Each customer has an individual database which is updated each time a transaction is processed.

Because payroll and benefits transactions are processed regularly and on a consistent schedule by the payroll and benefits processing company, this results in a large amount of HCM data being updated frequently and stored in the customer databases. The same processing company generally processes the transactions for a period of time, resulting in a consistent way HCM data is being stored. This allows for the ability to cross reference similar types of HCM data despite businesses being very different. Because the HCM data is collected as part of payroll and benefits transactions processed on a regular schedule, the HCM data collected is very accurate and timely. The current invention aggregates and transforms specific fields of HCM data in these customer databases, allowing an audience of one or more prospects or customers to compare its HCM to the HCM of a sample of other customers. The other customers making up the sample are generally chosen because they share one or more characteristics with the one or more prospects or customers which make up the audience. The comparison metrics provide the audience with accurate and up to date benchmark metrics against which to compare their metrics, easily identifying ways in which they differ from other “like” businesses making up the sample. This can help the audience identify ways in which they can eliminate waste, become more profitable, better manage their human capital and identify areas in which they are doing well compared to the sample.

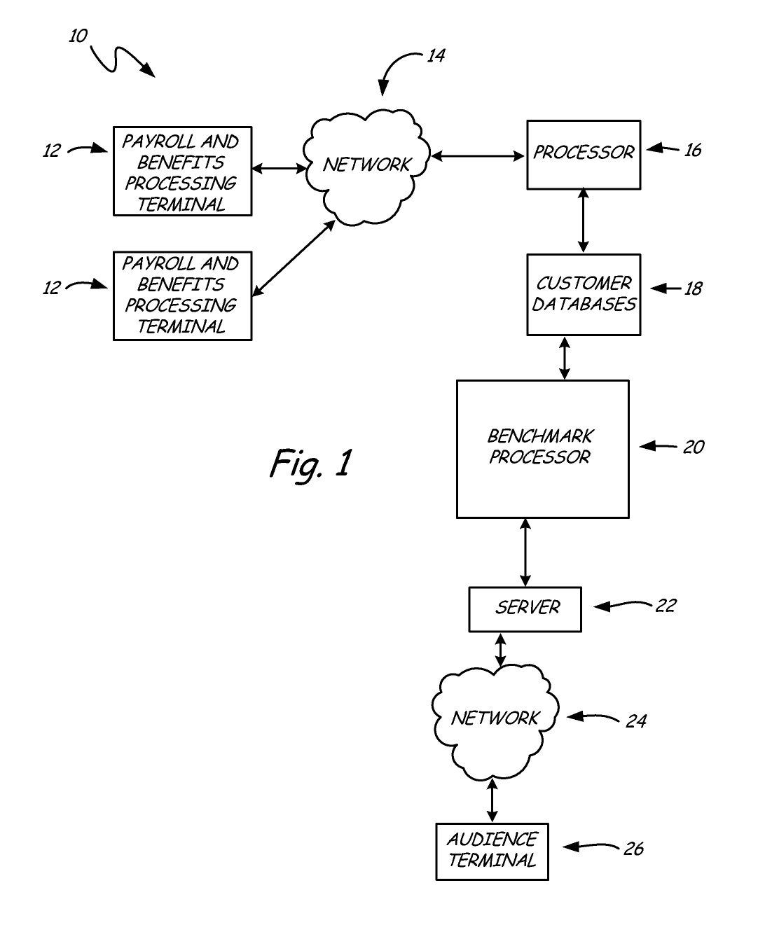

FIG. 1 is a block diagram illustrating a system for providing information by which an audience made of one or more prospects or customers of payroll and benefits processing may compare its human capital metrics with human capital metrics of other customers. System 10 includes customer payroll and benefits transaction terminals 12, network 14, processor 16, customer databases 18, benchmark processor 20, reporting system server 22, network 24, and audience terminal 26.

Customer payroll and benefits transaction terminals 12 are located at individual customer businesses. They can be the customer's computer through which they are accessing software of the payroll and benefits processing company. Customer payroll and benefits transaction terminals 12 communicate through network 14 to processor 16. Processor 16 processes the payroll and benefits transactions and sends the HCM data to customer databases 18. The payroll and benefits transaction processing may include: processing of employer and employee demographic data, employee compensation data, employer and employee taxation data, employer and employee benefits data, and ancillary services provided by the employer to result in the printing of payroll checks or electronic deposits to employee accounts. Each customer has a separate customer database 18, in which the HCM data for every payroll and benefits transaction for that customer is stored.

Benchmarking is performed by comparing HCM from an audience of one or more prospects or customers with aggregated HCM from a sample of other customers that may have one or more characteristics in common with the audience. Benchmarking processor 20 performs a series of processing steps with copies of HCM data retrieved from customer databases 18. These processing steps can include selecting customers of interest that have at least one characteristic in common with the audience, aggregating select fields of HCM data from customers of interest, creating a benchmark database with the aggregated HCM data, retrieving the select fields of HCM data from the customer databases of the one or more prospects or customers forming the audience, creating an audience database, deriving metrics from the audience database and the benchmark database, comparing the two sets of metrics, and producing a report comparing the two sets of metrics.

The report produced by benchmark processor 20 is then sent to the audience. Server 22 receives the report, and sends it through network 24 to audience terminal 26. Alternatively, the report could be delivered by hand, or by a mail service once produced by benchmark processor 20, without the need to use server 22, network 24 or audience terminal 26.

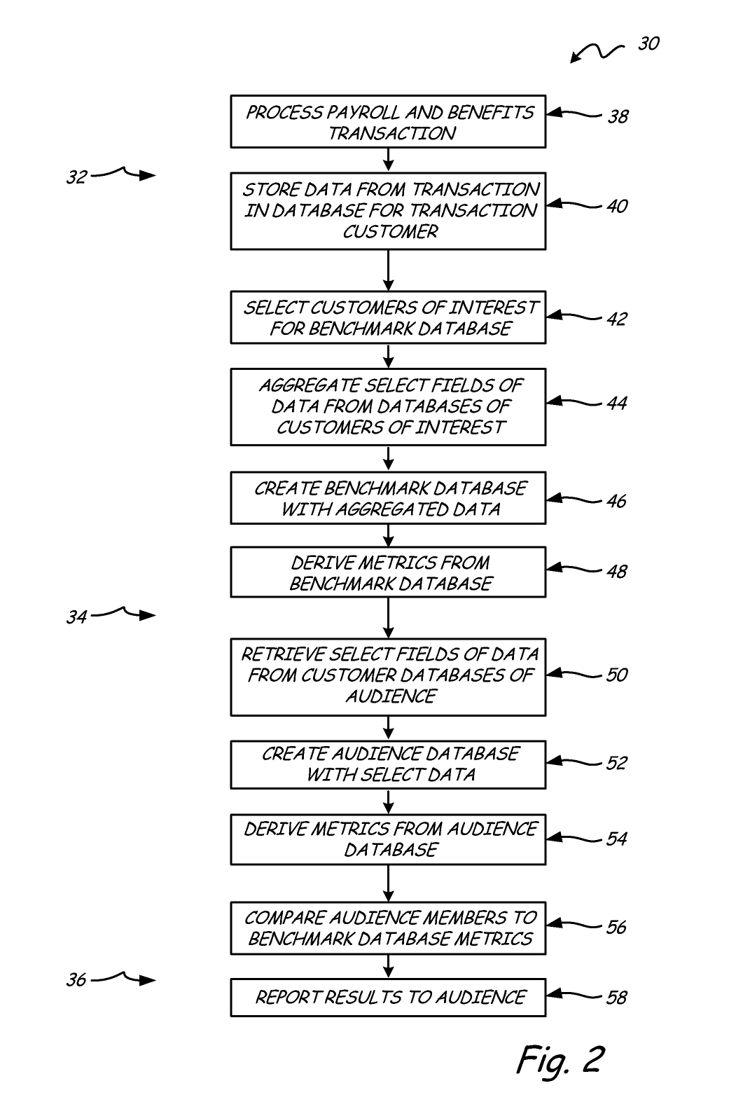

FIG. 2 is a block diagram illustrating a method of providing information by which an audience formed of one or more prospects or customers of payroll and benefits processing may compare its human capital metrics with human capital metrics of other customers. Method 30 includes three major parts: data acquisition portion 32, data processing portion 34 and distribution portion 36. Method 30 may be performed by system 10 of FIG. 1.

Data acquisition portion 32 includes processing a payroll and benefits transaction (step 38) and storing HCM data from the transaction in a database for the transaction customer (step 40). As mentioned in relation to FIG. 1, each customer has a separate customer database 18 (FIG. 1). Every time a transaction is processed for a customer, HCM data from the transaction is relayed to the customer database 18 for that customer. HCM data can include specific fields covering demographic data, employee data and financial data, and can specifically include fields such as number of persons employed, employee seniority, business personnel organization, salary, benefit information, etc.

Data processing portion 34, starts with selecting customers of interest for a benchmark database (step 42). The customers of interest are generally selected for having at least one characteristic in common with the audience (for whom the report is being generated). However, the customers of interest can be selected by many other means depending on the desire of the audience for whom the report is being generated. For example, the audience may want to have a comparison with businesses who have at least 50% female management. In this example, customers of interest would be customers who have at least 50% female management, with that information coming from the employee data in the customer databases. In another example, the audience could be a number of customers with businesses located in Arizona. They may desire a comparison of their HCM with the HCM of businesses located in Texas. In this case, customers located in Texas would be the customers of interest, and may not share any characteristics with the audience. In a third example, the audience may be a prospective customer who may wish to compare its HCM to HCM of businesses which have comparison reports generated for them quarterly. The customers of interest would be customers who are receiving comparison reports quarterly, and the audience, as a prospective customer, would have to provide its own HCM for the comparison as it does not have a customer database with HCM data due to it not yet being a customer, and therefore not having had any payroll and benefits transactions processed from which to collect HCM data.

Next in the data processing portion 34, select fields of HCM data from databases of customers of interest are aggregated (step 44). Benchmark database 20 is created with the aggregated HCM data (step 46). This benchmark database 20 represents a sample of the customers of interest. Metrics are then derived from benchmark database 20 (step 48). The select fields of HCM data from customer databases 18 of the one or more customers making up the audience are retrieved (step 50), and an audience database is created with the select HCM data (step 52). Metrics are then derived from the audience database (step 54). Finally, at step 56 the audience metrics (generated in step 54) are compared with the benchmark database metrics (generated in step 48).

The results of the comparison are then reported to the audience (step 58). The results can be reported in a variety of different formats, including in an electronic format (e.g., through a dashboard web portal provided by server 22) and in paper format. The reporting of the results of the comparison can also be done in a number of different ways, including showing the mean or median of metrics derived from the selected fields of data over time, plotting the metrics over time, showing the high and low ends of the data forming the metrics, and many other ways depending on the audience requirements.

Data acquisition portion 32 of method 30 results in very current and accurate HCM data for a plurality of different customers at any time. Therefore the metrics derived from this HCM data are more recent and more accurate than the survey methods used to collect data in the past. Furthermore, by storing all the raw HCM data from customer payroll and benefits transactions in customer databases and updating the data upon every payroll and benefits transaction, a customer can stay on top of trends within its industry by having reports comparing its metrics with metrics of similar or competitor businesses generated for it at certain time intervals throughout the year, for example, every quarter. This will enable a customer who has these reports generated to more quickly recognize areas in which its business could make changes to improve its HCM and therefore implement those changes sooner as well.

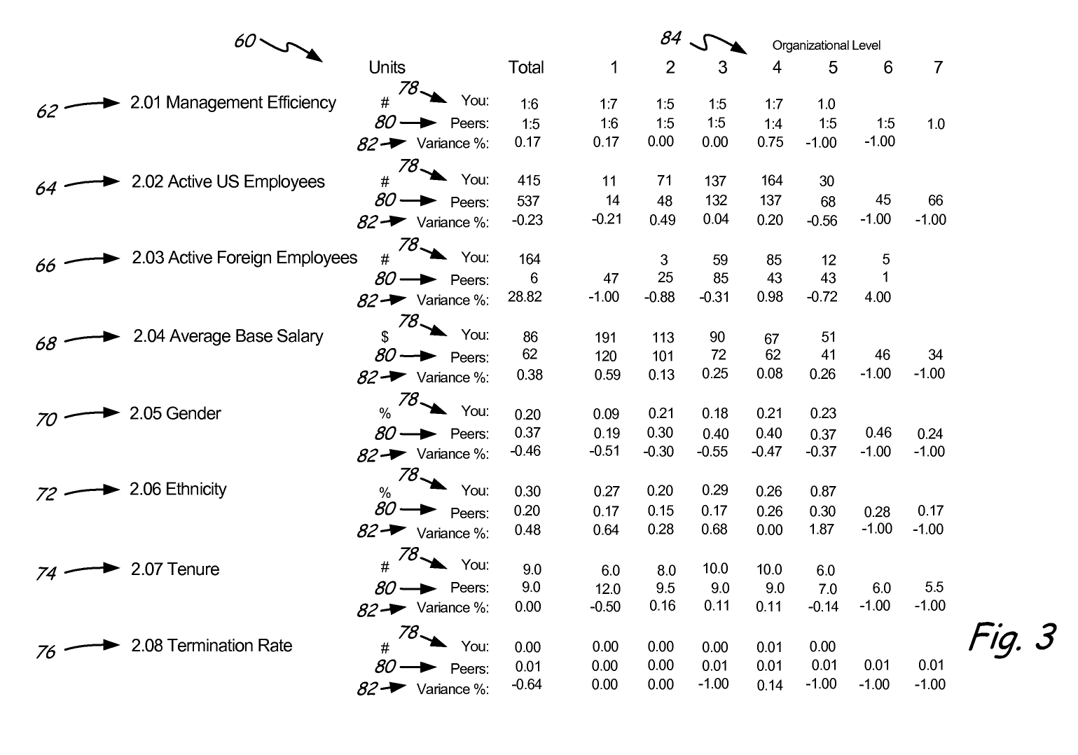

FIG. 3 is a report comparing the human capital metrics of an audience database to the human capital metrics of a benchmark database according to an embodiment of the current invention. Report 60 includes metrics on the selected fields of management efficiency 62, active U.S. employees 64, active foreign employees 66, average base salary 68, gender 70, ethnicity 72, tenure 74 and termination rate 76. Report 60 breaks this down for audience 78 (“you”) and benchmark database 80 (“peers”), while providing a calculated variance 82. Report 60 further breaks these metrics down into organizational levels 84, going from 1 to 7. The number and definition of the organizational levels can very depending on the type of business.

As mentioned above, the current invention collects, aggregates and transforms HCM data from payroll and benefits transactions to provide an audience information by which it may compare its HCM with HCM of a sample of other customers. Customers of interest were selected, in this case, customers in the same industry as the audience, for the report shown in FIG. 3. Select fields of HCM data (management efficiency 62, active U.S. employees 64, active foreign employees 66, average base salary 68, gender 70, ethnicity 72, tenure 74 and termination rate 76) were aggregated to create a benchmark database. Metrics were then derived from this benchmark database. The select fields of HCM data were then retrieved from the audience database (in this case a single customer) and aggregated to form an audience database. Metrics were derived from the audience database. The metrics derived in this case were the total number in each selected field, for the benchmark database and the audience database respectively, and the number at each organizational level in each select field to give a more in depth picture. The variance between the benchmark database metrics and the audience database metrics was also calculated for the total and at each organizational level.

An audience can use this benchmarked data to see where it varies based on its peers. For example, the fourth select field 68 shows average base salary in thousands of dollars. The average for the audience (“you”) 78 is $86,000 and the total for benchmark database (“peers”) 80 is $62,000. The variance 82 is 38%. The audience can see quite clearly that it pays a higher average salary than its peers, which may initially indicate that it should lower its salaries to get closer to market level. However, because the metrics are further broken down by organizational level, it can be seen that the salaries at organizational levels 2 and 4 are similar to peers average base salary at those levels. The large variance seems to come from peers having more lower paid employees (seen from select field 64 active U.S. employees at lower organizational levels 5-7) than the audience. So this in-depth analysis, showing aggregated peer data for comparison, allows the audience to have a very accurate picture of how it is doing relative to its peers, allowing it to have more accurate information to make better business decisions.

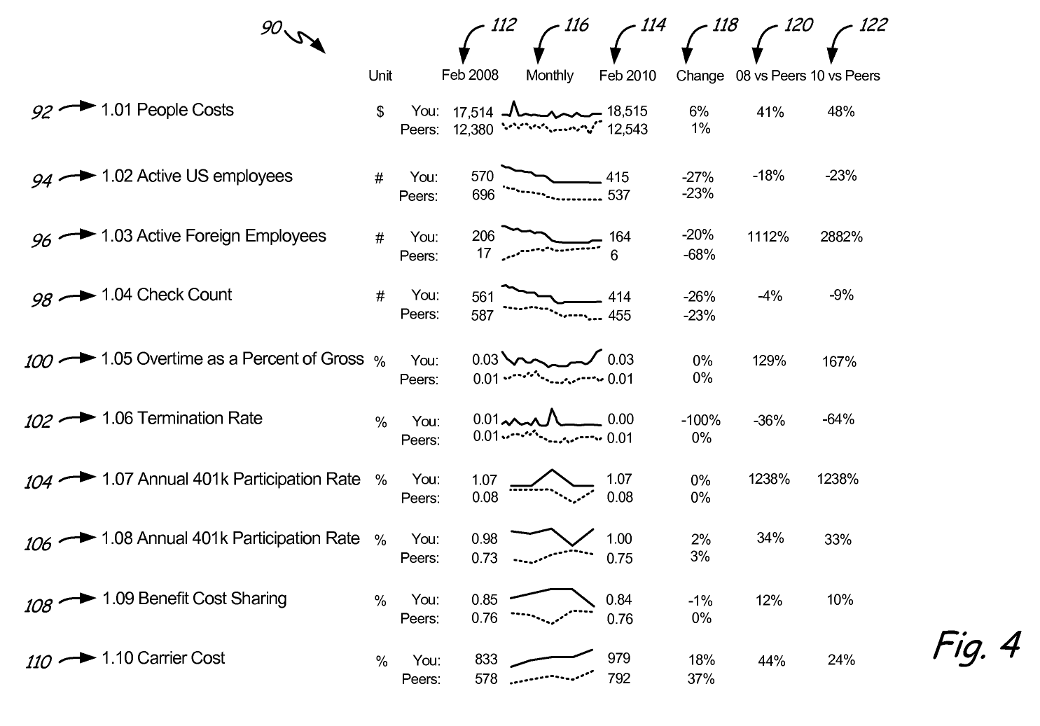

FIG. 4 is a report comparing the human capital metrics of an audience database to the human capital metrics of a benchmark database, and plotting the metrics over time. Report 90 includes the select HCM data fields of people costs 92, active U.S. employees 94, active foreign employees 96, check count 98, overtime as a percent of gross 100, termination rate 102, annual 401K contribution rate 104, annual 401K participation rate 106, benefit cost sharing 108 and carrier cost 110. Report 90 shows: metrics 112 for February 2008, metrics 114 for February 2010, plotted metrics 116 between the dates of February 2008 and February 2010, percentage change 118 between the metrics of those dates, audience database metrics in 2008 vs. benchmark database metrics in 2008 120, and audience database metrics in 2010 vs. benchmark database metrics in 2010 122.

As in FIG. 3, HCM data for the report shown in FIG. 4 was collected based on the processing of payroll and benefits transactions. Customers of interest were chosen by selecting customers in the same industry as the audience. In this embodiment, only HCM data from February 2008 to February 2010 was retrieved to form the benchmark database and the audience database. Metrics were derived for the select fields (people costs 92, active U.S. employees 94, active foreign employees 96, check count 98, overtime as a percent of gross 100, termination rate 102, annual 401K contribution rate 104, annual 401K participation rate 106, benefit cost sharing 108 and carrier cost 110) by month or quarterly if no monthly metrics could be derived. These metrics were then plotted 116 to graphically show the variance between the audience (“you”) and benchmark database sample (“peers”) between February 2008 and February 2010.

This embodiment of report 90 allows an audience (in this case, one customer) to easily see, through the use of plotting data over time, how it was doing in a select field at various points in a set period of time. This may be helpful if, for example, the audience implemented a new policy in December of 2008. The audience can then see how it was doing relative to its peers (customers of interest in the benchmark database) in select fields before the policy was implemented as well as after the implementation. This may enable the audience to be able to more accurately and quickly evaluate whether the policy change had the desired effect.

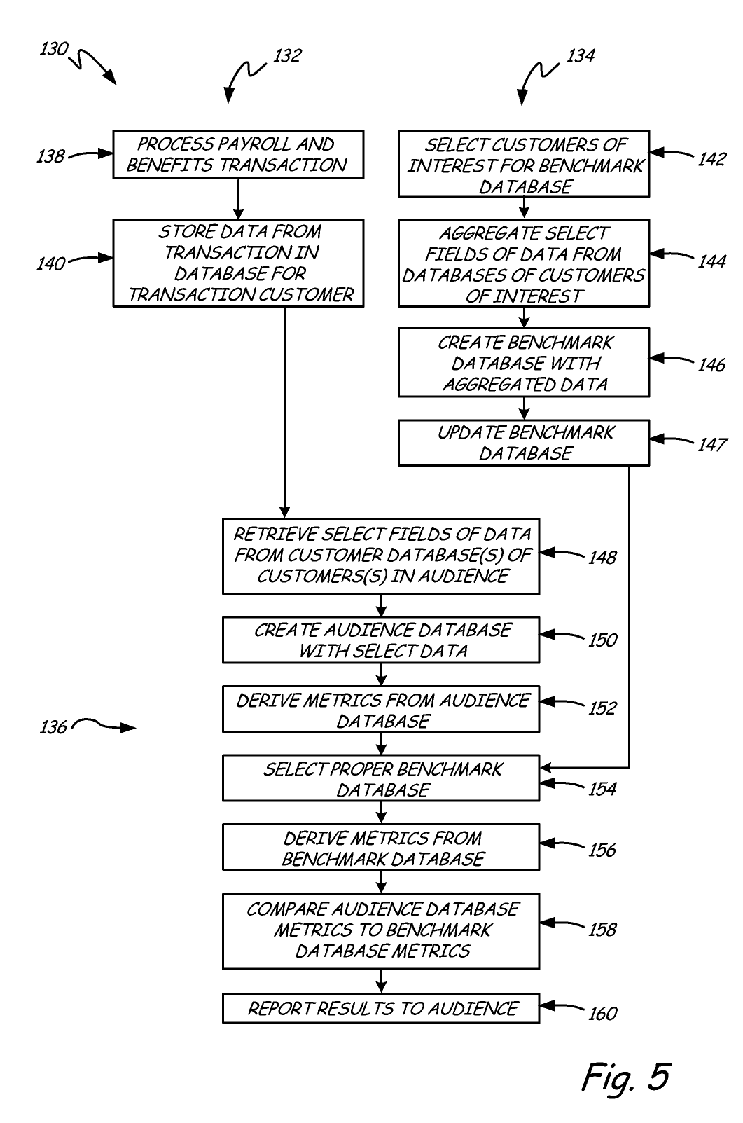

FIG. 5 is a block diagram illustrating a method of providing information by which an audience made of one or more prospects or customers of payroll and benefits processing may compare its human capital metrics with human capital metrics of other customers according to another embodiment. Method 130 includes three major parts: data acquisition portion 132, benchmark processing portion 134 and audience processing/reporting portion 136.

Data acquisition portion 132 includes processing a payroll and benefits transaction (step 138) and storing HCM data from the transaction in a database for the transaction customer (step 140). As before, each customer has a separate customer database, and each time a transaction is processed for a customer, HCM data from the transaction is relayed to the customer database for that customer.

Benchmark processing portion 134, starts with selecting customers of interest for a benchmark database (step 142). Next, steps are performed to aggregate select fields of HCM data from databases of customers of interest (step 144), to create a benchmark database with aggregated data (step 146), and to update the benchmark database periodically as needed (step 147).

Audience processing/reporting portion 136 includes retrieving select fields of HCM data from customer databases (step 148) of the one or more customers making up the audience; creating audience database with select HCM data (step 150); and deriving metrics from audience database (step 152). It further includes selecting proper benchmark database (step 154); deriving metrics from benchmark database (step 156); comparing audience database metrics to benchmark database metrics (step 158); and reporting results to audience (step 160).

In this embodiment, a large number of benchmark databases are created and updated based on anticipated future customer requests. This enables quicker comparison reports to an audience, as the benchmark databases are ready for >?, and the steps of selecting customers of interest, aggregating HCM data from them, and forming the benchmark database(s) from FIG. 2 can be done in advance of an audience request. For example, if there are a number of customers in the oil exploration industry, and it is anticipated that at least one will likely desire to have comparison reports, one or more benchmark databases related to oil exploration companies will be formed through the benchmark processing steps (142-146). These oil exploration benchmark databases will be updated (through step 147) every time a transaction is processed with a customer of interest (in the oil exploration industry). This will ensure that benchmark databases are readily available for this industry whenever an audience requests a comparison report.

In summary, the current invention includes a system and a method which provides an audience made of one or more customers of payroll and benefits processing information for it to compare its human capital metrics with human capital metrics of other customers. By storing a large amount of HCM data from processing payroll and benefits transactions for customers and updating that HCM data every time a new transaction is processed, a large amount of up to date and accurate HCM data is available for use with the current invention. The method and system are able to retrieve this HCM data, and aggregate and transform pieces of it to form databases and then derive metrics for comparisons. These comparisons allow business to accurately reflect on how its HCM compare to HCM of other customers.

Furthermore, because so much HCM data is stored in relation to the payroll and benefits transactions, a customer can easily tailor both the metrics it would like to compare and the customers of interest to compare its metrics against. Also, the invention allows an audience to compare its metrics to metrics of customers of interest while still protecting the identities of individual customers of interest. This is done by aggregating the HCM data of customers of interest to form a sample, from which metrics are derived. Therefore no individual customer metrics are given to another customer, thus protecting customer confidentiality.

While the invention has mostly been discussed in relation to the audience (for whom the comparison report is being generated) being a single customer, the audience could be made of a number of customers. For example, the audience could consist of a number of businesses in health insurance located on the west coast, and they may desire a comparison report showing their metrics compared to the metrics of health insurance companies on the east coast, or throughout the country. In that case, forming the audience database could involve retrieving the select fields of data from all the customer databases of the businesses which form the audience, aggregating that data, and then deriving metrics. Other audiences could include trade groups, academia, the government and any other person or group interested in human capital management.

While the invention has been described with reference to an exemplary embodiment(s), it will be understood by those skilled in the art that various changes may be made and equivalents may be substituted for elements thereof without departing from the scope of the invention. In addition, many modifications may be made to adapt a situation or material to the teachings of the invention without departing from the essential scope thereof. Therefore, it is intended that the invention not be limited to the embodiment(s) disclosed, but that the invention will include all embodiments falling within the scope of the appended claims.

1. A method of providing information by which an audience of one or more prospects or customers of payroll and benefits processing may compare its human capital metrics with human capital metrics of other customers, the method comprising:
maintaining a customer database for each customer that includes demographic data, employee data and financial data for that customer;
updating each customer database based on periodically processing payroll and benefits transactions for that customer;
creating a benchmark database by aggregating selected fields of data from databases of customers of interest so that the benchmark database represents a sample of customers of interest;
creating an audience database for retrieving the selected fields of data from the customer databases for the one or more prospects or customers forming the audience for the audience;
comparing the audience database to the benchmark database; and
reporting results of the comparison to the audience.

2. The method of claim 1, wherein the comparing the audience database to the benchmark database further comprises:
deriving metrics from the benchmark database;
deriving metrics of the audience database; and
comparing the metrics of the audience database to the metrics of the benchmark database.

3. The method of claim 1, wherein the method is automatically performed for the audience at set intervals throughout the calendar year.

4. The method of claim 1, wherein the customer database is updated each time a payroll and benefits transaction is processed for that customer.

5. The method of claim 1, wherein the payroll and benefits transactions comprise one or more of the following: employee demographic data, employee compensation data, employee and employer taxation data, employee benefits data, employer benefits data, and ancillary services provided.

6. The method of claim 1, wherein each of the customers of interest from which data has been aggregated to form the benchmark database share at least one characteristic in common with the audience.

7. The method of claim 1, wherein the step of reporting the results of the comparison to the audience further comprises:
reporting the results in an electronic format.

8. The method of claim 1, wherein the step of reporting the results of the comparison to the audience further comprises:
plotting the data in the benchmark database and the data in the audience database to show specific fields over a set period of time.

9. A system for providing information by which an audience of one or more prospects or customers of payroll and benefits processing may compare its human capital metrics with human capital metrics of other customers, the system comprising:
a processing system for processing payroll and benefits transactions and updating a plurality of customer databases based on the processing, each database including demographic data, employee data and financial data for one customer;
a benchmarking system with a benchmarking processor which creates a benchmark database by aggregating selected fields of data from databases of customers of interest; creates an audience database by retrieving the selected fields of data from the customer databases of the one or more prospects or customers in the audience; and compares the audience database with the benchmarking database; and
a reporting system which reports results of the comparison to the audience.

10. The system of claim 9, wherein the benchmarking database represents a sample of the selected data from customers of interest.

11. The system of claim 10, wherein the benchmarking system compares the audience database with the benchmarking database by deriving metrics from the benchmarking database, deriving metrics from the audience database and comparing the metrics.

12. The system of claim 9, wherein the benchmarking system automatically creates a benchmark database, automatically creates an audience database and compares the benchmark database with the audience database; and the reporting system automatically reports the results of the comparison to the audience at set intervals throughout the year.

13. The system of claim 9, wherein the reporting system reports the results in an electronic format.

14. The system of claim 9, wherein the payroll and benefits transactions comprise one or more of the following: employee demographic data, employee compensation data, employee and employer taxation data, employee benefits data, employer benefits data, and ancillary services provided.

15. The system of claim 9, wherein the results reported plot the data in the benchmark database and the data in the audience database to show specific fields over a set period of time.

16. A method of providing information by which an audience comprising one or more prospects or customers of payroll and benefits processing may compare its human capital metrics with human capital metrics of other customers, the method comprising:
maintaining a customer database for each customer that includes demographic data, employee data and financial data for that customer;
updating each customer database based on processing payroll and benefits transactions for that customer;
maintaining benchmark databases, each benchmark database created by aggregating selected fields of data from databases of customers of interest so that each benchmark database represents a sample of customers of interest for that benchmark database;
creating an audience database by retrieving the selected fields of data from the customer databases of the one or more prospects or customers comprising the audience;
comparing the audience database to one of the benchmark databases; and
reporting results of the comparison to the audience.

17. The method of claim 16, wherein the comparing of the audience database to one of the benchmark databases further comprises:
deriving metrics from the benchmark database;
deriving metrics from the audience database; and
comparing the metrics of the benchmark database to the metrics of the audience database.

18. The method of claim 16, wherein the customers of interest for each benchmark database are selected based on demographic data, employee data and financial data.

19. The method of claim 16, wherein the benchmark database selected for the comparison is chosen based on the data in that benchmark database and the customers of interest from whom the data comes.

20. The method of claim 16, wherein the customer databases and the benchmark databases are updated every time a payroll and benefits transaction is processed.
